(19) United States
(12) Patent Application Publication
(10) Pub. No.: US 2025/0142019 A1
(43) Pub. Date: May 1, 2025

(54) TECHNIQUES FOR ENABLING SWITCHING BETWEEN HETEROGENOUS DISPLAYPORT SOURCE AND SINK DEVICES

(71) Applicant: Icron Technologies Corporation, Burnaby (CA)

(72) Inventors: Bhupinder Singh Rathore, Coquitlam (CA); Ardeshir Saghafi, Surrey (CA)

(73) Assignee: Icron Technologies Corporation, Burnaby (CA)

(21) Appl. No.: 18/922,196

(22) Filed: Oct. 21, 2024

Related U.S. Application Data
(60) Provisional application No. 63/594,352, filed on Oct. 30, 2023.

(51) Int. Cl. H04N 7/08; G06F 3/14

(52) U.S. Cl. CPC H04N 7/08; G06F 3/14

(57) ABSTRACT

In some embodiments, a computer-implemented method for coupling one or more DisplayPort source devices to a plurality of DisplayPort sink devices is provided. A matrix management engine receives capabilities of the plurality of DisplayPort sink devices. The matrix management engine determines a maximum common quality based on the capabilities of the plurality of DisplayPort sink devices. The matrix management engine, provides capabilities based on the maximum common quality for presentation to the one or more DisplayPort source devices.

### CROSS REFERENCE TO RELATED APPLICATION

This application claims the benefit of Provisional Application No. 63/594,352, filed Oct. 30, 2023, the entire disclosure of which is hereby incorporated by reference herein for all purposes.

### BACKGROUND

DisplayPort communication is described in detail at least in “VESA DisplayPort Standard, Version 2.1,” released in October 2022, by VESA. This document, the content of which is known to one of ordinary skill in the art, is hereby incorporated by reference herein in its entirety, along with any earlier versions or related documents mentioned therein (collectively hereinafter “the DisplayPort specification”), for all purposes. The DisplayPort specification describes physical and logical techniques for communication between a DisplayPort source device which generates video (and, in some embodiments, audio) and a DisplayPort sink device which presents the video (and, in some embodiments, audio). The DisplayPort specification also describes topologies wherein one or more branch devices (which are similar to repeaters, splitters, or hubs) are present between the DisplayPort source device and the DisplayPort sink device.

The DisplayPort specification includes some limits on communication between the DisplayPort source device and the DisplayPort sink device. For example, the DisplayPort specification describes direct communication between the DisplayPort source device and the DisplayPort sink device, and assumes that a link is established between a given DisplayPort source device and a given DisplayPort sink device. In previous techniques, if a switching device is interposed between one or more DisplayPort source devices and one or more DisplayPort sink devices, it has been assumed that the DisplayPort link will be retrained when a pairing between a DisplayPort sink device and a DisplayPort source device is changed.

What is desired are devices and techniques that allow seamless digital switching between DisplayPort source devices and DisplayPort sink devices, such that re-training a link between a DisplayPort source device and a DisplayPort sink device does not have to occur upon switching. What is further desired are techniques that support such functionality even if not all DisplayPort source devices or DisplayPort sink devices coupled to the switching device support the same capabilities.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method for coupling one or more DisplayPort source devices to a plurality of DisplayPort sink devices is provided. A matrix management engine receives capabilities of the plurality of DisplayPort sink devices. The matrix management engine determines a maximum common quality based on the capabilities of the plurality of DisplayPort sink devices. The matrix management engine, provides capabilities based on the maximum common quality for presentation to the one or more DisplayPort source devices.

In some embodiments, a computing device is provided that is configured to receive capabilities of a plurality of DisplayPort sink devices; determine a maximum common quality based on the capabilities of the DisplayPort sink devices; and provide capabilities based on the maximum common quality for presentation to one or more DisplayPort source devices.

In some embodiments, a system for enabling coupling of one or more DisplayPort source devices to a plurality of DisplayPort sink devices is provided. The system comprises a matrix management engine configured to: receive capabilities of the plurality of DisplayPort sink devices; determine a maximum common quality based on the capabilities of the plurality of DisplayPort sink devices; and provide capabilities based on the maximum common quality for presentation to the one or more DisplayPort source devices.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic illustration of a non-limiting example embodiment of a system according to various aspects of the present disclosure.

FIG. 2 is a block diagram illustrating a non-limiting example embodiment of a matrix video switching device according to various aspects of the present disclosure.

FIG. 3A-FIG. 3B are a flowchart that illustrates a non-limiting example embodiment of a method for enabling switching between one or more DisplayPort source devices and multiple heterogenous DisplayPort sink devices according to various aspects of the present disclosure.

FIG. 4 is a flowchart that illustrates a non-limiting example embodiment of a method for handling a newly connected DisplayPort sink device according to various aspects of the present disclosure.

FIG. 5 is a flowchart that illustrates a non-limiting example embodiment of a method for handling disconnection of a DisplayPort sink device according to various aspects of the present disclosure.

### DETAILED DESCRIPTION

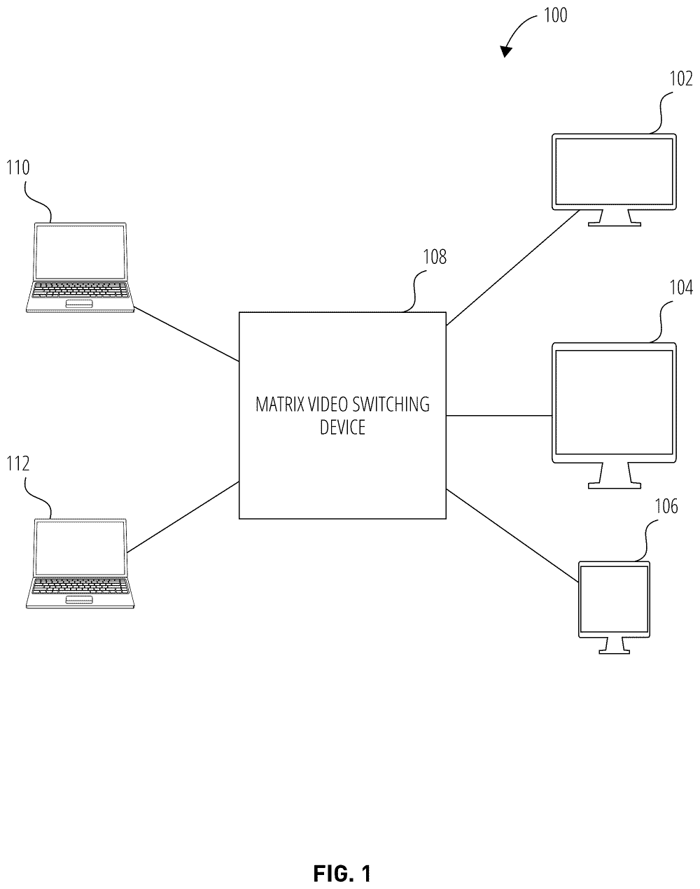

FIG. 1 is a schematic illustration of a non-limiting example embodiment of a system according to various aspects of the present disclosure. In the system 100, a matrix video switching device 108 provides switching capabilities between one or more DisplayPort source devices, such as first DisplayPort source device 110 and second DisplayPort source device 112, and a plurality of DisplayPort sink devices, such as first DisplayPort sink device 102, second DisplayPort sink device 104, and third DisplayPort sink device 106.

The DisplayPort source devices may be any type of device that outputs data according to the DisplayPort specification. Typically, the DisplayPort source devices may include one or more of a laptop computing device, a desktop computing device, a tablet computing device, or any other type of computing device that outputs DisplayPort data. More than one different type of DisplayPort source device may be present in the system 100. For example, the first DisplayPort source device 110 may be a laptop computing device, while the second DisplayPort source device 112 may be a desktop computing device.

The DisplayPort sink devices may be any type of device that receives data according to the DisplayPort specification. Often, the DisplayPort sink devices may be display devices, but this does not exclude other types of DisplayPort sink devices from being present in the system 100. For example, the DisplayPort sink devices may include repeaters, extension devices, digital recording devices, loudspeakers (for presenting audio data transmitted via DisplayPort), USB devices (for processing USB data transmitted over DisplayPort), additional downstream matrix video switching devices 108, or any other type of device that receives data according to the DisplayPort specification.

As shown, the matrix video switching device 108 is configured to have one or more DisplayPort source devices coupled to upstream facing ports of the matrix video switching device 108, and to selectively transmit DisplayPort data from a given DisplayPort source device to one of a plurality of DisplayPort sink devices coupled to downstream facing ports of the matrix video switching device 108. For example, matrix video switching device 108 may provide communication between the first DisplayPort source device 110 and the first DisplayPort sink device 102, as well as between the second DisplayPort source device 112 and the second DisplayPort sink device 104.

The matrix video switching device 108 is also configured to support switching the couplings between DisplayPort source devices and DisplayPort sink devices. For example, the matrix video switching device 108 may switch the first DisplayPort source device 110 from communicating with the first DisplayPort sink device 102 to instead communicate with the third DisplayPort sink device 106. The matrix video switching device 108 may also be configured to allow for DisplayPort source devices and DisplayPort sink devices to be added to or removed from the system 100 without disturbing the communication connections that are already established.

In some embodiments, the matrix video switching device 108 is configured to allow seamless switching of couplings between DisplayPort source devices and DisplayPort sink devices within the system 100. However, the Display Port sink devices within the system 100 may be heterogenous. That is, one or more of the DisplayPort sink devices within the system 100 may support different capabilities than the other DisplayPort sink devices (e.g., different maximum bit rates, different maximum DisplayPort lanes, etc.). This presents significant technical problems in implementing the matrix video switching device 108, at least because DisplayPort communication is initially set up with a lengthy handshaking protocol. This handshaking protocol includes the DisplayPort source device requesting capabilities (e.g., DisplayPort Configuration Data (DPCD) and/or Extended Display Information Data (EDID)) supported by the DisplayPort sink device, choosing a mode in which to communicate that is supported by the DisplayPort sink device, and conducting link training to establish DisplayPort lanes with the DisplayPort sink device. If switching to a DisplayPort sink device that cannot support a current data quality currently being output by the DisplayPort source device, the DisplayPort source device would have to perform the handshaking protocol again, and would act as if the DisplayPort sink device had been disconnected and reconnected (thus breaking the desired seamless switching functionality). In some embodiments, the matrix video switching device 108 addresses these problems by determining a maximum common quality supported by all of the DisplayPort sink devices within the system 100. In response to a query for capabilities from a connected DisplayPort source device, the matrix video switching device 108 presents itself as a single DisplayPort sink device having capabilities representing the maximum common quality. As such, the matrix video switching device 108 ensures that all of the DisplayPort sink devices within the system 100 will be able to support the DisplayPort data transmitted by the DisplayPort source device.

Further description of these techniques for addressing these technical problems are disclosed in the description below.

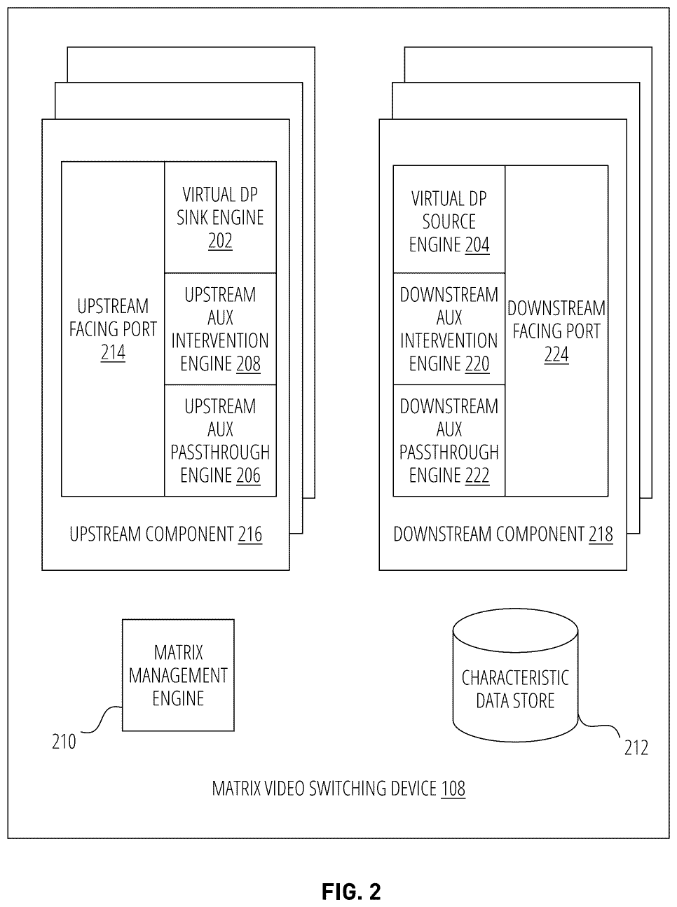

FIG. 2 is a block diagram illustrating a non-limiting example embodiment of a matrix video switching device according to various aspects of the present disclosure. In some embodiments, the elements illustrated within the matrix video switching device 108 are contained within a single housing. In some embodiments, one or more upstream components 216 and one or more downstream components 218 may be present in separate housings and connected via an extension medium, such as a wired medium (e.g., ethernet, fiber optic cable, USB, Fire Wire, Thunderbolt, etc.) or a wireless network (e.g., WiFi, 4G, 5G, Bluetooth, etc.).

As illustrated, the matrix video switching device 108 includes one or more upstream components 216, a plurality of downstream components 218, a matrix management engine 210, and a characteristic data store 212.

As used herein, “engine” refers to logic embodied in hardware or software instructions, which can be written in one or more programming languages, including but not limited to C, C++, C#, COBOL, JAVA™, PHP, Perl, HTML, CSS, Javascript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device. Typically, the matrix management engine 210 may be provided as an ASIC configured to provide the functionality of the matrix management engine 210 described herein, though in some embodiments, other types of hardware may be used to implement the functionality of the matrix management engine 210.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure. Typically, the characteristic data store 212 may be provided using random access memory (RAM), flash memory, or another computer-readable medium contained within a housing of the matrix video switching device 108 in order to ensure reliability and speed of communication with the other elements of the matrix video switching device 108, though in some embodiments, other types of data stores may be used.

In the illustrated embodiment, the matrix video switching device 108 includes a plurality of downstream components 218. In some embodiments, each downstream component 218 may itself be provided as a distinct piece of hardware (e.g., a self-contained element such as a daughter board, integrated circuit, or other element having one or more ASICs, FPGAs, or other hardware elements) configured to provide the illustrated downstream facing port 224, virtual DP source engine 204, downstream AUX intervention engine 220, and downstream AUX passthrough engine 222. In some embodiments, some of the elements other than the downstream facing port 224 may be shared between separate downstream components 218. For example, a single virtual DP source engine 204, downstream AUX intervention engine 220, and/or downstream AUX passthrough engine 222 may be shared between multiple downstream components 218. In some embodiments, each downstream component 218 may not be a distinct piece of hardware from other portions of the matrix video switching device 108, but they are illustrated as such in FIG. 2 for ease of discussion.

As illustrated, each downstream component 218 includes a downstream facing port 224, a virtual DP source engine 204, a downstream AUX intervention engine 220, and a downstream AUX passthrough engine 222. The downstream facing port 224 is a full-size DisplayPort connector, a Mini DisplayPort connector, a USB Type-C connector, a Thunderbolt connector, or any other type of hardware socket capable of communicating data according to the DisplayPort specification.

In some embodiments, the virtual DP source engine 204 is configured to provide functionality of a DisplayPort source to a DisplayPort sink device coupled to the downstream facing port 224, such as link training, providing placeholder data, and providing DisplayPort data received from an upstream component 216.

In some embodiments, the downstream AUX intervention engine 220 is configured to exchange some types of AUX information with a DisplayPort sink device coupled to the downstream facing port 224, such as transmitting requests for DPCD and EDID information and receiving responses thereto, and to provide the intercepted information to the matrix management engine 210 or other components of the matrix video switching device 108 instead of relaying it to an upstream component 216. In some embodiments, the downstream AUX passthrough engine 222 is configured to pass AUX information of other types (e.g., HDCP information, etc.) directly between a DisplayPort sink devices coupled to the downstream facing port 224 and an upstream component 216.

In some embodiments, the downstream component 218 may include other elements not illustrated, such as elements for transmitting DisplayPort data received via one or more lanes received from an upstream component 216 to a DisplayPort sink device coupled to the downstream facing port 224. Non-limiting examples of such components are described in commonly owned U.S. Pat. No. 10,078,997, issued Sep. 18, 2018 (hereinafter “the incorporated '997 patent”), the entire disclosure of which is incorporated by reference herein for all purposes, and so are not described in further detail herein. While the incorporated '997 patent describes the bridging of DisplayPort information over an extension medium, similar techniques may be used within a single matrix video switching device 108 to connect between upstream components 216 and downstream components 218.

In the illustrated embodiment, the matrix video switching device 108 includes one or more upstream components 216. As with the downstream components 218, the upstream components 216 may each be provided as distinct pieces of hardware (e.g., a self-contained element such as a daughter board, integrated circuit, or other element having one or more ASICs, FPGAs, or other hardware elements) configured to provide the illustrated upstream facing port 214, virtual DP sink engine 202, upstream AUX intervention engine 208, and upstream AUX passthrough engine 206. In some embodiments, some of the elements other than the upstream facing port 214 may be shared between upstream components 216 (e.g., a single virtual DP sink engine 202, upstream AUX intervention engine 208, and/or upstream AUX passthrough engine 206 may be shared between multiple upstream components 216). In some embodiments, each upstream component 216 may not be a distinct piece of hardware from other portions of the matrix video switching device 108, but they are illustrated as such in FIG. 2 for ease of discussion.

As illustrated, each upstream component 216 includes an upstream facing port 214, a virtual DP sink engine 202, an upstream AUX intervention engine 208, and an upstream AUX passthrough engine 206. The upstream facing port 214 is a full-size DisplayPort connector, a Mini DisplayPort connector, a USB Type-C connector, a Thunderbolt connector, or any other type of hardware socket capable of communicating data according to the DisplayPort specification.

In some embodiments, the virtual DP sink engine 202 is configured to provide functionality of a DisplayPort sink to a DisplayPort source device coupled to the upstream facing port 214, such as link training, and transmitting DisplayPort data received from a DisplayPort source device coupled to the upstream facing port 214 to a downstream component 218.

In some embodiments, the upstream AUX intervention engine 208 is configured to exchange some types of AUX information with a DisplayPort source device coupled to the upstream facing port 214, such as receiving requests from the DisplayPort source device for capabilities and providing responses to the DisplayPort source device as instructed by the matrix management engine 210 instead of relaying such requests to a downstream component 218. In some embodiments, the upstream AUX passthrough engine 206 is configured to pass AUX information of other types (e.g., HDCP information, etc.) directly between the DisplayPort source device and a downstream component 218. As with the downstream component 218, the upstream component 216 may include other elements not illustrated in FIG. 2, such as elements for transmitting DisplayPort data received via one or more lanes received from a DisplayPort source device to a downstream component 218. Some non-limiting examples of such elements are described in the incorporated '997 patent, and so are not described in further detail herein for the sake of brevity.

In some embodiments, the matrix management engine 210 is configured to control the other elements of the matrix video switching device 108 in order to implement seamless many-to-many switching between DisplayPort source devices and DisplayPort sink devices coupled to the matrix video switching device 108. In some embodiments, the matrix video switching device 108 is configured to determine a maximum common quality supported by all DisplayPort sink devices coupled to the matrix video switching device 108, and to provide the maximum common quality to the upstream components 216 such that the matrix video switching device 108 appears to each DisplayPort source device as a single DisplayPort sink device having capabilities associated with the maximum common quality. In some embodiments, the matrix video switching device 108 is configured to receive instructions to connect a given upstream component 216 and downstream component 218 so that a DisplayPort source device and a DisplayPort sink device connected thereto can communicate, to cause the connection to be implemented, and to cause the connections to be adjusted (e.g., causing different upstream components 216 and downstream components 218 to be connected) upon receiving instructions to do so.

Further details about the configuration of each of these elements are provided below.

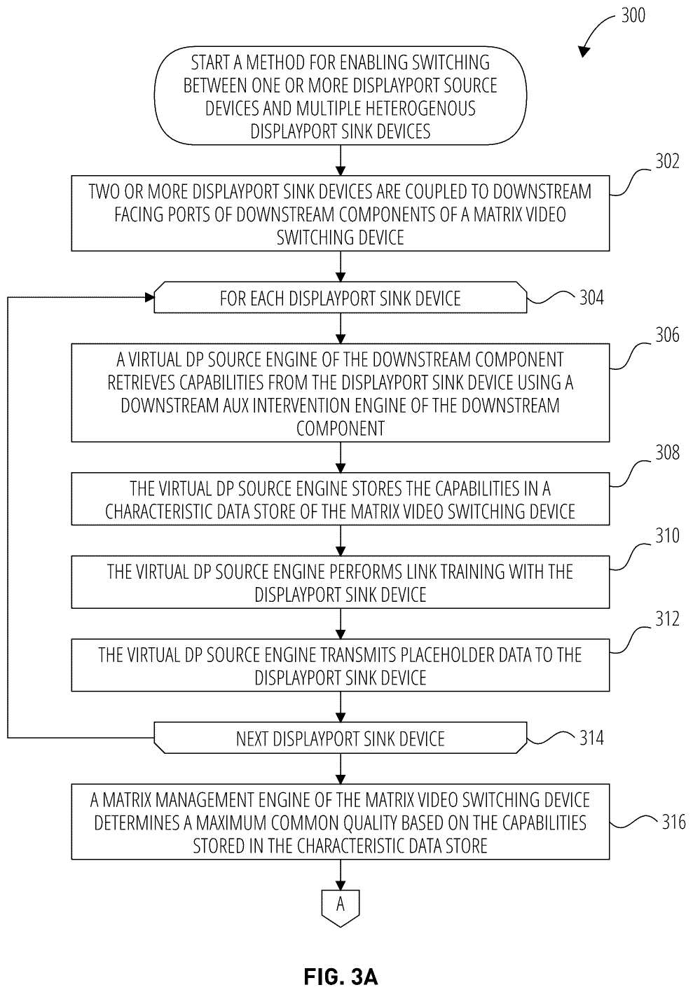

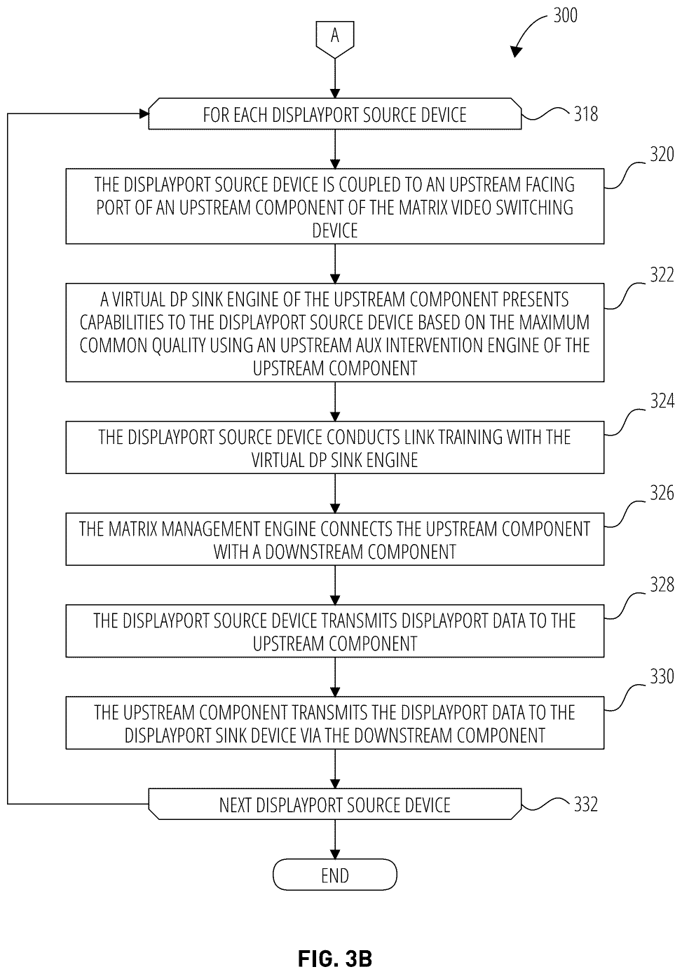

FIG. 3A-FIG. 3B are a flowchart that illustrates a non-limiting example embodiment of a method for enabling switching between one or more DisplayPort source devices and multiple heterogenous DisplayPort sink devices according to various aspects of the present disclosure. In the method 300, the matrix video switching device 108 presents itself as a single DisplayPort sink device to each of the coupled DisplayPort source devices having capabilities of the maximum common quality of the coupled DisplayPort sink devices, and the matrix video switching device 108 controls which of the DisplayPort source devices communicate with which of the DisplayPort sink devices in order to realize seamless many-to-many switching between the devices.

From a start block, the method 300 proceeds to block 302, where two or more DisplayPort sink devices of the system 100 (for example, first DisplayPort sink device 102, second DisplayPort sink device 104, and third DisplayPort sink device 106) are coupled to downstream facing ports 224 of downstream components 218 of a matrix video switching device 108. In some embodiments, cables are physically connected to the downstream facing ports 224 and ports of the DisplayPort sink devices. In some embodiments, coupling a DisplayPort sink device to a downstream facing port 224 causes a hot plug detect (HPD) signal to be generated and detected by the downstream component 218, thus causing the downstream component 218 to perform the actions for reading the DisplayPort sink device for use in the system 100 as described below.

The method 300 then advances to a for-loop defined between a for-loop start block 304 and a for-loop end block 314, wherein each of the coupled DisplayPort sink devices in the system 100 that are coupled to the matrix video switching device 108 are readied for use. The for-loop is illustrated as processing each DisplayPort sink device serially for case of discussion, but in some embodiments, the for-loop may be executed at least partially concurrently for two or more of the DisplayPort sink devices.

From for-loop start block 304, the method 300 advances to block 306, where a virtual DP source engine 204 of the downstream component 218 retrieves capabilities from the DisplayPort sink device using a downstream AUX intervention engine 220 of the downstream component 218, and at block 308, the virtual DP source engine 204 stores the capabilities in a characteristic data store 212 of the matrix video switching device 108. The downstream component 218 uses the downstream AUX intervention engine 220 because the retrieved capabilities may be processed by the matrix video switching device 108 without being transmitted in unedited form to the upstream components 216. The capabilities may be retrieved by the virtual DP source engine 204 requesting DisplayPort Configuration Data (DPCD) and/or Extended Display Information Data (EDID) from the DisplayPort sink device per the DisplayPort specification. The capabilities represent modes supported by the DisplayPort sink device, and may include one or more of one or more supported bandwidths, one or more supported compression types, one or more supported DisplayPort lane counts, one or more supported training patterns, one or more supported color spaces, one or more supported video resolutions, one or more supported video timings, or whether audio is supported.

It has been found during testing of a wide variety of DisplayPort sink devices that if capability data is requested without subsequently performing link training and transmitting DisplayPort data fairly soon thereafter, the DisplayPort sink device is likely to enter a low power consumption state that will take an undesirable amount of time to recover from once a connection is formed between the downstream component 218 and an upstream component 216. Accordingly, at block 310, the virtual DP source engine 204 performs link training with the DisplayPort sink device, and at block 312, the virtual DP source engine 204 transmits placeholder data to the DisplayPort sink device. In some embodiments, the virtual DP source engine 204 may choose a maximum bandwidth, a highest-quality training pattern, a maximum number of lanes, or an otherwise highest-quality connection supported by the DisplayPort sink device for link training, so that DisplayPort data of any quality supported by the DisplayPort sink device may be communicated. The placeholder data may include DisplayPort data with blank video, DisplayPort data with static splash screen data, DisplayPort data with screen saver or other preset video data, or any other suitable DisplayPort data.

The method 300 then proceeds to the for-loop end block 314. If any further DisplayPort sink devices were coupled to the matrix video switching device 108 at block 302 that have not yet been processed, then the method 300 returns from for-loop end block 314 to for-loop start block 304 to process the next DisplayPort sink device.

Once all DisplayPort sink devices that were coupled to the matrix video switching device 108 have been processed, the method 300 proceeds from for-loop end block 314 to block 316. At block 316, a matrix management engine 210 of the matrix video switching device 108 determines a maximum common quality based on the capabilities stored in the characteristic data store. In some embodiments, the maximum common quality may be determined by comparing the capabilities stored in the characteristic data store 212 in each of a set of categories, and selecting the lowest value for each category (that is, the value that is guaranteed to be supported by all of the DisplayPort sink devices). Though the lowest value is selected, this results in the maximum common value being determined because the lowest value in the set is the maximum value supported by all of the devices.

For example, if two DisplayPort sink devices support a per-lane data rate of 20 Gbit/s, one DisplayPort sink device supports a per-lane data rate of 8.1 Gbit/s, and one DisplayPort sink device supports a per-lane data rate of 5.4 Gbit/s, the value for a per-lane data rate category would be 5.4 Gbit/s, because all four of the DisplayPort sink devices support the 5.4 Gbit/s data rate. Likewise, if two DisplayPort sink devices support four lanes, one DisplayPort sink device supports two lanes, and one DisplayPort sink device supports one lane, the value for a data lanes category would be one lane, because all four of the DisplayPort sink devices support one lane. Similar comparisons may be made for other categories of capabilities, such that a complete description of the maximum common quality of DisplayPort data that can be handled by all of the DisplayPort sink devices is determined.

From block 316, the method 300 proceeds to a continuation terminal (“terminal A”). From terminal A (FIG. 3B), the method 300 proceeds to a for-loop defined between for-loop start block 318 and for-loop end block 332, wherein each DisplayPort source device in the system 100 (such as first DisplayPort source device 110 and second DisplayPort source device 112) is processed to connect the DisplayPort source device to a DisplayPort sink device. In some embodiments, a single DisplayPort source device may be coupled to the matrix video switching device 108, such that it may be switched between the multiple DisplayPort sink devices.

From the for-loop start block 318, the method 300 proceeds to block 320, where the DisplayPort source device is coupled to an upstream facing port 214 of an upstream component 216 of the matrix video switching device 108. As with the DisplayPort sink devices the DisplayPort source device may be coupled to the upstream facing port 214 using a DisplayPort cable. In some embodiments, the virtual DP source engine 204 may transmit a hot plug detect (HPD) signal to the DisplayPort source device upon coupling in order to notify the DisplayPort source device of the presence of the matrix video switching device 108.

At block 322, a virtual DP sink engine 202 of the upstream component 216 presents capabilities to the DisplayPort source device based on the maximum common quality using an upstream AUX intervention engine 208 of the upstream component 216. The upstream AUX intervention engine 208 receives the queries for capabilities (e.g., EDID and/or DPCD) from the DisplayPort source device, and provides them to the virtual DP sink engine 202 (or the matrix management engine 210 for processing). The matrix management engine 210 had previously determined the maximum common quality at block 316, and capabilities of the maximum common quality (e.g., EDID and/or DPCD representing the maximum common quality) are returned by the virtual DP sink engine 202 and upstream AUX intervention engine 208. In some embodiments, the upstream AUX intervention engine 208 may replace certain aspects of the EDID and/or DPCD with synthetic data instead of copying data that was provided by one or more of the DisplayPort sink devices. For example, a manufacturer ID and/or manufacturer product code associated with the matrix video switching device 108 itself may be used instead of corresponding data retrieved from any of the DisplayPort sink devices. As another example, if one or more DisplayPort sink devices responded to requests for capabilities with information that was not compliant with more standards (e.g., the DisplayPort standard, or standards for EDID or DPCD), the upstream AUX intervention engine 208 may replace the non-standard information with appropriate information that is standards-compliant.

At block 324, the DisplayPort source device conducts link training with the virtual DP sink engine 202. The virtual DP sink engine 202 responds in a manner compliant with the DisplayPort standard, such that a DisplayPort connection between the DisplayPort source device and the upstream component 216 is established.

At block 326, the matrix management engine 210 connects the upstream component 216 with a downstream component 218. In some embodiments, the connection is a logical connection, such that the matrix management engine 210 instructs the upstream component 216 which of the downstream components 218 it should communicate with, and vice versa, using any suitable technique, such as by providing identifiers of the paired components, by providing network addresses of the paired components, or any other suitable technique. In some embodiments, the matrix management engine 210 may configure a physical component, including but not limited to a relay or other circuitry that creates a communication path between the upstream component 216 and the downstream component 218.

In some embodiments, the connection between the upstream component 216 and the downstream component 218 may include additional link training so that native DisplayPort lanes may be transmitted directly from the DisplayPort source device to the downstream component 218 or DisplayPort sink device over the physical layer without further processing. For example, the DisplayPort source device may link train a connection all the way from the DisplayPort source device to the downstream component 218 (or even all the way to the DisplayPort sink device), if the upstream component 216 and downstream component 218 provide support for Link-Training Tunable PHY Repeater (LTTPR) functionality. In such embodiments, the connection between the upstream component 216 and downstream component 218 at block 326 may occur before link training begins at block 324.

At block 328, the DisplayPort source device transmits DisplayPort data to the upstream component 216, and at block 330, the upstream component 216 transmits the DisplayPort data to the DisplayPort sink device via the downstream component 218. In some embodiments (such as those described above that use LTTPR functionality), the DisplayPort data may be transmitted from the DisplayPort source device to the DisplayPort sink device through the upstream component 216 and downstream component 218 via the physical layer. In some embodiments, the upstream component 216 may terminate the DisplayPort lanes (e.g., using the virtual DP sink engine 202) and provide the data in another physical format to the downstream component 218, which then repackages it with new timing for transmission as DisplayPort lanes to the DisplayPort sink device (e.g., using the virtual DP source engine 204). In some embodiments, the upstream component 216 may deserialize, decode, and descramble the DisplayPort data to extract the video and/or audio information, and provide the extracted video and/or audio information to the downstream component 218. The downstream component 218 may then scramble, encode, and serialize the video and/or audio information for transmission as DisplayPort data to the DisplayPort sink device, as described in the incorporated '997 patent.

Once the connection is made between the upstream component 216 and the downstream component 218, the matrix video switching device 108 may continue to use the upstream AUX intervention engine 208 and downstream AUX intervention engine 220 to intercept some types of AUX communication related to configuration of the DisplayPort sink device, and may use the upstream AUX passthrough engine 206 and downstream AUX passthrough engine 222 to directly pass through other AUX communication that is directly usable by the DisplayPort sink device and DisplayPort source device, including but not limited to High-bandwidth Digital Content Protection (HDCP) information.

The method 300 then proceeds to for-loop end block 332. If further DisplayPort source devices remain to be processed, then the method 300 returns from for-loop end block 332 to for-loop start block 318 to process the next DisplayPort source device. Otherwise, the method 300 advances from for-loop end block 332 to an end block, and terminates.

Once the DisplayPort sink device and DisplayPort source device(s) have been coupled using method 300, the system 100 may continue to operate as desired, with each of the DisplayPort source device(s) coupled to a corresponding DisplayPort sink device. In some embodiments, the matrix video switching device 108 may allow switching the couplings after the initial configuration. For example, if first DisplayPort source device 110 is initially coupled to first DisplayPort sink device 102, the matrix video switching device 108 may accept a command (e.g., a user input on a button, a switch, or another interface of the matrix video switching device 108; a message transmitted via the AUX channel from software executing on a DisplayPort source device; a message received over a network, etc.) that causes the coupling to switch the first DisplayPort source device 110 from being coupled to the first DisplayPort sink device 102 to instead, for example, being coupled to the second DisplayPort sink device 104.

Upon the change in couplings, the matrix video switching device 108 may cause the downstream component 218 coupled to the first DisplayPort sink device 102 to transmit placeholder video data, and may cause the downstream component 218 coupled to the second DisplayPort sink device 104 to transmit the DisplayPort data from the first DisplayPort source device 110 instead of the placeholder video data, thus allowing the switch between monitors to occur immediately (e.g., without conducting link training again). Such techniques for instant video switching between different devices across an extension medium were described in commonly owned U.S. Pat. No. 10,051,205, issued Aug. 14, 2018, the entire disclosure of which is hereby incorporated by reference herein for all purposes. The present disclosure adds significantly to this previous patent in several ways. As one example, by determining the maximum common quality and presenting the maximum common quality to the DisplayPort source device(s), the matrix management engine 210 enables this type of instant switching even if the DisplayPort sink devices in the system 100 have widely differing capabilities.

As another example, in some embodiments, the matrix video switching device 108 is configured to reconsider the maximum common quality upon detecting a change in the connected DisplayPort sink devices. By doing so, the matrix video switching device 108 can ensure that the maximum common quality is never higher than can be supported by all of the connected DisplayPort sink devices, and can also increase the maximum common quality when appropriate.

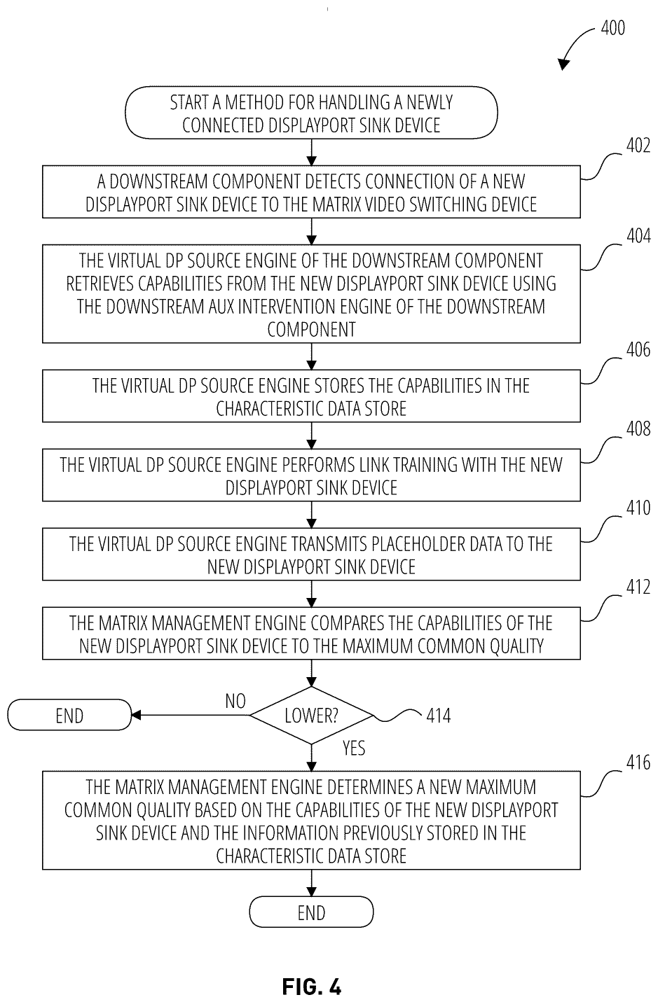

FIG. 4 is a flowchart that illustrates a non-limiting example embodiment of a method for handling a newly connected DisplayPort sink device according to various aspects of the present disclosure. In the method 400, the matrix video switching device 108 reconsiders the maximum common quality when a new DisplayPort sink device is connected, in case the new DisplayPort sink device is not capable of supporting the same maximum common quality as the previously connected DisplayPort sink devices.

From a start block, the method 400 proceeds to block 402, where a downstream component 218 detects connection of a new DisplayPort sink device to the matrix video switching device 108. As described above at block 302, the new DisplayPort sink device may be connected to the matrix video switching device 108 via a cable, and the downstream component 218 may detect the connection by receiving an HPD signal from the new DisplayPort sink device.

At block 404, the virtual DP source engine 204 of the downstream component 218 retrieves capabilities from the new DisplayPort sink device using the downstream AUX intervention engine 220 of the downstream component 218, and at block 406, the virtual DP source engine 204 stores the capabilities in the characteristic data store 212. As described above at block 306, the capabilities may be retrieved by the virtual DP source engine 204 requesting DPCD and/or EDID from the new DisplayPort sink device per the DisplayPort specification.

Similar to blocks 310-312, at block 408, the virtual DP source engine 204 performs link training with the new DisplayPort sink device, and at block 410 the virtual DP source engine 204 transmits placeholder data to the new DisplayPort sink device. By performing link training and transmitting placeholder data, the matrix video switching device 108 prevents the DisplayPort sink device from undesirably entering a low-power state.

At block 412, the matrix management engine 210 compares the capabilities of the new DisplayPort sink device to the maximum common quality. The method 400 then advances to a decision block 414, where a determination is made regarding whether the capabilities of the new DisplayPort sink device are lower than the maximum common quality. In other words, the matrix management engine 210 determines whether the new DisplayPort sink device can handle DisplayPort data of the maximum common quality, or whether the capabilities of the DisplayPort sink device are inadequate to support the maximum common quality. If the capabilities of the new DisplayPort sink device are not lower than the maximum common quality, the new DisplayPort sink device can support the current maximum common quality and the result of decision block 414 is NO. The method 400 then proceeds to an end block and terminates, since no change to the maximum common quality is needed.

Otherwise, if the capabilities of the new DisplayPort sink device are lower than the maximum common quality, the new DisplayPort sink device cannot support the current maximum common quality. The result of decision block 414 is then YES, and the method 400 proceeds to block 416.

At block 416, the matrix management engine 210 determines a new maximum common quality based on the capabilities of the new DisplayPort sink device and the information previously stored in the characteristic data store 212. The determination is similar to the determination described above in block 316. In some embodiments, all of the previously stored capabilities and the capabilities of the new DisplayPort sink device will be analyzed to determine the new maximum common quality. In some embodiments, the capabilities of the new DisplayPort sink device and the existing maximum common quality will be compared to determine the lowest value in each category, so that only two comparisons are performed. In some embodiments, the capabilities of the new DisplayPort sink device may be used as the new maximum common quality without further detailed analysis.

Once a new maximum common quality is determined, newly connected DisplayPort source devices would be provided the new maximum common quality. Any suitable action may be taken to ensure that existing switched connections comply with the new maximum common quality. In some embodiments, existing connections between DisplayPort source devices and DisplayPort sink devices that use capabilities greater than the new maximum common quality may stay intact until switched. In some embodiments, a DisplayPort source device may be prevented from switching to the new DisplayPort sink device if it is currently using capabilities greater than the new maximum common quality. In some embodiments, when a new maximum common quality is determined, a DisplayPort source device that undergoes a switch from one DisplayPort sink device to another may receive a HPD signal generated by the virtual DP sink engine 202 to cause the DisplayPort source device to treat the switching action as if the DisplayPort sink device disconnected and reconnected, thus causing the DisplayPort source device to request capabilities again and receive the new maximum common quality.

Then method 400 then proceeds to an end block and terminates.

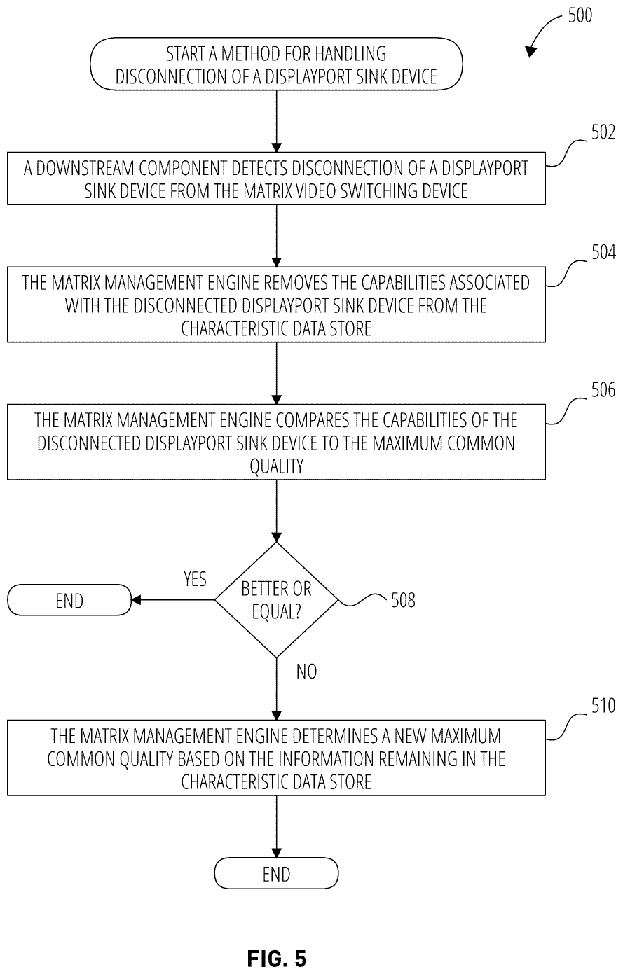

If a DisplayPort sink device is disconnected from the matrix video switching device 108, some embodiments of the matrix video switching device 108 may do nothing and allow the existing maximum common quality to persist. However, in some embodiments, the matrix video switching device 108 may take the disconnection as an opportunity to determine if a higher maximum common quality is available due to disconnection of a low-performing DisplayPort sink device. FIG. 5 is a flowchart that illustrates a non-limiting example embodiment of a method for handling disconnection of a DisplayPort sink device according to various aspects of the present disclosure.

From a start block, the method 500 proceeds to block 502, where a downstream component 218 detects disconnection of a DisplayPort sink device from the matrix video switching device 108. Disconnection may be detected using any suitable technique, including but not limited to detecting the absence of an HPD signal.

At block 504, the matrix management engine 210 removes the capabilities associated with the disconnected DisplayPort sink device from the characteristic data store 212. In some embodiments, the capabilities may be stored in the characteristic data store 212 in a way that is associated with the downstream component 218 to which the DisplayPort sink device is connected, and so by knowing the downstream component 218 that detected the disconnection, the matrix management engine 210 knows which set of stored capabilities is relevant.

At block 506, the matrix management engine 210 compares the capabilities of the disconnected DisplayPort sink device to the maximum common quality. The comparison is similar to the comparison performed at block 316. At decision block 508, a determination is made based on whether the capabilities of the disconnected DisplayPort sink device are better than or equal to the current maximum common quality (e.g., values for each category in the capabilities are compared to see whether they are higher than or equal to corresponding values in the current maximum common quality).

If the capabilities and EDID of the disconnected DisplayPort sink device are better than or equal to the current maximum common quality, then the maximum common quality is still applicable to the remaining DisplayPort sink devices. Accordingly, the result of decision block 508 is YES, and the method 500 proceeds to an end block and terminates.

Otherwise, if the capabilities of the disconnected DisplayPort sink device are not better than or equal to the current maximum common quality, then the maximum common quality may be lower than what is supported by the remaining DisplayPort sink devices. Accordingly, the result of decision block 508 is NO, and the method 500 proceeds to block 510, where the matrix management engine 210 determines a new maximum common quality based on the information remaining in the characteristic data store 212. The determination may be made using a technique similar to that described in block 316, just without considering the capabilities that had been removed from the characteristic data store 212 at block 504.

Once the new maximum common quality is determined, it may be handled in any suitable way. In some embodiments, newly connected DisplayPort source devices may be provided with the new maximum common quality. In some embodiments, already connected DisplayPort source devices may be provided an HPD signal to cause the DisplayPort source devices to detect a disconnection and reconnection of the matrix video switching device 108, thus causing the DisplayPort source devices to request capabilities again. In some embodiments, the existing connections may be maintained at the existing quality, and DisplayPort source devices may be transmitted the HPD disconnection/reconnection signal when a switch between DisplayPort sink devices occurs.

The method 500 then proceeds to an end block and terminates.

While illustrative embodiments have been illustrated and described, it will be appreciated that various changes can be made therein without departing from the spirit and scope of the invention.

1. A computer-implemented method for coupling one or more DisplayPort source devices to a plurality of DisplayPort sink devices, the method comprising:
receiving, by a matrix management engine, capabilities of the plurality of DisplayPort sink devices;
determining, by the matrix management engine, a maximum common quality based on the capabilities of the plurality of DisplayPort sink devices; and
providing, by the matrix management engine, capabilities based on the maximum common quality for presentation to the one or more DisplayPort source devices.

2. The computer-implemented method of claim 1, wherein determining the maximum common quality includes comparing one or more of a supported bandwidth, a supported compression type, a supported lane count, a supported training pattern, a supported color space, a supported video resolution, a supported video timing, or a presence of audio support.

3. The computer-implemented method of claim 1, further comprising, for each DisplayPort sink device of the plurality of DisplayPort sink devices:
requesting DisplayPort Configuration Data (DPCD) and Extended Display Identification Data (EDID) from the DisplayPort sink device;
performing link training with the DisplayPort sink device based on the maximum common quality; and
transmitting placeholder data to the DisplayPort sink device.

4. The computer-implemented method of claim 3, further comprising:
associating a first DisplayPort source device of the one or more DisplayPort source devices with a first DisplayPort sink device of the plurality of DisplayPort sink devices to cause DisplayPort data from the first DisplayPort source device to be transmitted to the first DisplayPort sink device instead of the placeholder data.

5. The computer-implemented method of claim 4, wherein requesting DPCD and EDID from the DisplayPort sink device includes intercepting and processing AUX data without passing through the AUX data; and
wherein causing DisplayPort data to be transmitted includes passing through AUX data between the first DisplayPort source device and the first DisplayPort sink device.

6. The computer-implemented method of claim 4, further comprising:
in response to a command to switch the first DisplayPort source device from the first DisplayPort sink device to a second DisplayPort sink device of the plurality of DisplayPort sink devices:
associating the first DisplayPort source device with the second DisplayPort sink device instead of the first DisplayPort sink device to cause DisplayPort data from the first DisplayPort source device to be transmitted to the second DisplayPort sink device instead of the placeholder data; and
transmitting placeholder data to the first DisplayPort sink device.

7. The computer-implemented method of claim 1, further comprising:
receiving, by the matrix management engine, capabilities of a new DisplayPort sink device added to the plurality of DisplayPort sink devices;
comparing, by the matrix management engine, the capabilities of the new DisplayPort sink device to the maximum common quality; and
in response to determining that the capabilities of the new DisplayPort sink device are lower than the maximum common quality, updating the maximum common quality based on the capabilities of the new DisplayPort sink device.

8. The computer-implemented method of claim 1, further comprising:
determining, by the matrix management engine, that a DisplayPort sink device of the plurality of DisplayPort sink devices has been disconnected;
comparing, by the matrix management engine, capabilities of the disconnected DisplayPort sink device to the maximum common quality; and
in response to determining that the capabilities of the disconnected DisplayPort sink device are not better than or equal to the maximum common quality, updating the maximum common quality based on the DisplayPort sink devices of the plurality of DisplayPort sink devices that remain connected.

9. A computing device configured to:
receive capabilities of a plurality of DisplayPort sink devices;
determine a maximum common quality based on the capabilities of the DisplayPort sink devices; and
provide capabilities based on the maximum common quality for presentation to one or more DisplayPort source devices.

10. The computing device of claim 9, wherein determining the maximum common quality includes comparing one or more of a supported bandwidth, a supported compression type, a supported lane count, a supported training pattern, a supported color space, a supported video resolution, a supported video timing, or a presence of audio support.

11. The computing device of claim 9, further configured to:
receive capabilities of a new DisplayPort sink device added to the plurality of DisplayPort sink devices;
compare the capabilities of the new DisplayPort sink device to the maximum common quality; and
in response to determining that the capabilities of the new DisplayPort sink device are lower than the maximum common quality, update the maximum common quality based on the capabilities of the new DisplayPort sink device.

12. The computing device of claim 9, further configured to:
determine that a DisplayPort sink device of the plurality of DisplayPort sink devices has been disconnected;
compare capabilities of the disconnected DisplayPort sink device to the maximum common quality; and
in response to determining that the capabilities of the disconnected DisplayPort sink device are not better than or equal to the maximum common quality, update the maximum common quality based on the DisplayPort sink devices of the plurality of DisplayPort sink devices that remain connected.

13. A system for enabling coupling of one or more DisplayPort source devices to a plurality of DisplayPort sink devices, the system comprising:
a matrix management engine configured to:
receive capabilities of the plurality of DisplayPort sink devices;
determine a maximum common quality based on the capabilities of the plurality of DisplayPort sink devices; and
provide capabilities based on the maximum common quality for presentation to the one or more DisplayPort source devices.

14. The system of claim 13, wherein determining the maximum common quality includes comparing one or more of a supported bandwidth, a supported compression type, a supported lane count, a supported training pattern, a supported color space, a supported video resolution, a supported video timing, or a presence of audio support.

15. The system of claim 13, further comprising a plurality of downstream components, wherein each downstream component includes a downstream facing port and a virtual DP source engine, wherein the virtual DP source engine is configured to:
request DisplayPort Configuration Data (DPCD) and Extended Display Identification Data (EDID) from a DisplayPort sink device coupled to the downstream facing port;
provide the DPCD and EDID to the matrix management engine;
perform link training with the DisplayPort sink device; and
transmit placeholder data to the DisplayPort sink device.

16. The system of claim 13, further comprising one or more upstream components;
wherein each upstream component includes an upstream facing port and a virtual DP sink engine; and
wherein the matrix management engine is further configured to:
associate an upstream component having a first DisplayPort source device coupled thereto with a downstream component having a first DisplayPort sink device coupled thereto to cause DisplayPort data from the first DisplayPort source device to be transmitted to the first DisplayPort sink device instead of placeholder data.

17. The system of claim 16, wherein each upstream component further includes:
an upstream AUX intervention engine configured to provide DPCD and EDID information based on the maximum common quality in response to requests received from a DisplayPort source device coupled to the upstream facing port; and
an upstream AUX passthrough engine configured to pass through AUX data from the DisplayPort source device to a downstream component.

18. The system of claim 16, wherein the matrix management engine is further configured to:
in response to a command to switch the first DisplayPort source device from the first DisplayPort sink device to a second DisplayPort sink device of the plurality of DisplayPort sink devices:
associate the upstream component having the first DisplayPort source device coupled thereto with a downstream component having the second DisplayPort sink device coupled thereto instead of the downstream component having the first DisplayPort sink device coupled thereto to cause DisplayPort data from the first DisplayPort source device to be transmitted to the second DisplayPort sink device instead of the placeholder data; and
cause placeholder data to be transmitted to the first DisplayPort sink device.

19. The system of claim 13, wherein the matrix management engine is further configured to:
receive capabilities of a new DisplayPort sink device added to the plurality of DisplayPort sink devices;
compare the capabilities of the new DisplayPort sink device to the maximum common quality; and
in response to determining that the capabilities of the new DisplayPort sink device are lower than the maximum common quality, update the maximum common quality based on the capabilities of the new DisplayPort sink device.

20. The system of claim 13, wherein the matrix management engine is further configured to:
determine that a DisplayPort sink device of the plurality of DisplayPort sink devices has been disconnected;
compare capabilities of the disconnected DisplayPort sink device to the maximum common quality; and
in response to determining that the capabilities of the disconnected DisplayPort sink device are not better than or equal to the maximum common quality, update the maximum common quality based on the DisplayPort sink devices of the plurality of DisplayPort sink devices that remain connected.
